(19) United States
(12) Patent Application Publication
(10) Pub. No.: US 2025/0118846 A1
(43) Pub. Date: Apr. 10, 2025

(54) BATTERY PACK

(71) Applicant: TOYOTA JIDOSHA KABUSHIKI KAISHA, Toyota-shi Aichi (JP)

(72) Inventors: Junki SUGIMOTO, Nisshin-shi Aichi (JP); Shigeyuki INOUE, Toyota-shi Aichi (JP); Akikazu MATSUDA, Kasugai-shi Aichi (JP)

(73) Assignee: TOYOTA JIDOSHA KABUSHIKI KAISHA, Toyota-shi Aichi (JP)

(21) Appl. No.: 18/892,648

(22) Filed: Sep. 23, 2024

(30) Foreign Application Priority Data
Oct. 10, 2023 (JP) 2023-175491

(51) Int. Cl. H01M 50/242; H01M 50/209; H01M 50/358

(52) U.S. Cl. CPC H01M 50/242; H01M 50/209; H01M 50/358

(57) ABSTRACT

A battery pack includes: a plurality of battery modules; a frame-shaped skeleton portion disposed on the battery modules; and an upper surface portion disposed on the skeleton portion. Further, the upper surface portion is fixed to the skeleton portion with a fixing force in a manner that the fixing with skeleton portion is released with a pressure generated when at least one of the battery modules emits smoke.

### CROSS-REFERENCE TO RELATED APPLICATION(S)

The present application claims priority to and incorporates by reference the entire contents of Japanese Patent Application No. 2023-175491 filed in Japan on Oct. 10, 2023.

### BACKGROUND

The present disclosure relates to a battery pack.

Japanese Unexamined Patent Application Publication No. 2021-528296 discloses a battery cell housing provided with an emergency vent opening for discharging gas when the battery cells emit smoke.

### SUMMARY

There is a need for providing a battery pack capable of achieving counter measures against both external force stress and discharging smoke.

According to an embodiment, a battery pack includes: a plurality of battery modules; a frame-shaped skeleton portion disposed on the battery modules; and an upper surface portion disposed on the skeleton portion. Further, the upper surface portion is fixed to the skeleton portion with a fixing force in a manner that the fixing with skeleton portion is released with a pressure generated when at least one of the battery modules emits smoke.

### BRIEF DESCRIPTION OF THE DRAWINGS

FIG. 1 is a perspective view illustrating a configuration of a battery pack according to an embodiment;

FIG. 2 is a perspective view illustrating a configuration of a battery module, the skeleton portion and the upper surface portion in the battery pack according to an embodiment;

FIG. 3 is a perspective view illustrating a state of the skeleton portion and the upper surface portion in a normal state in the battery pack according to an embodiment;

FIG. 4 is a perspective view illustrating a state of the skeleton portion and the upper surface portion at the time of smoke generation of the battery module in the battery pack according to the embodiment; and

FIG. 5 is a perspective view illustrating a state at the time of smoke generation of the battery module in the battery pack according to the embodiment.

### DETAILED DESCRIPTION

In the technique disclosed in Japanese Unexamined Patent Application Publication No. 2021-528296, it is difficult to achieve both external force stress (stress input from the outside) and smoke control measures.

A battery pack according to an embodiment of the present disclosure will be described with reference to the drawings. In addition, components in the following embodiments include those which can be substituted and easily by those skilled in the art, or those which are substantially the same.

A battery pack according to an embodiment is used as a battery of a vehicle such as a Battery Electric Vehicle (BEV), a Hybrid Electric Vehicle (HEV), a Plug-in Hybrid Electric Vehicle (PHEV).

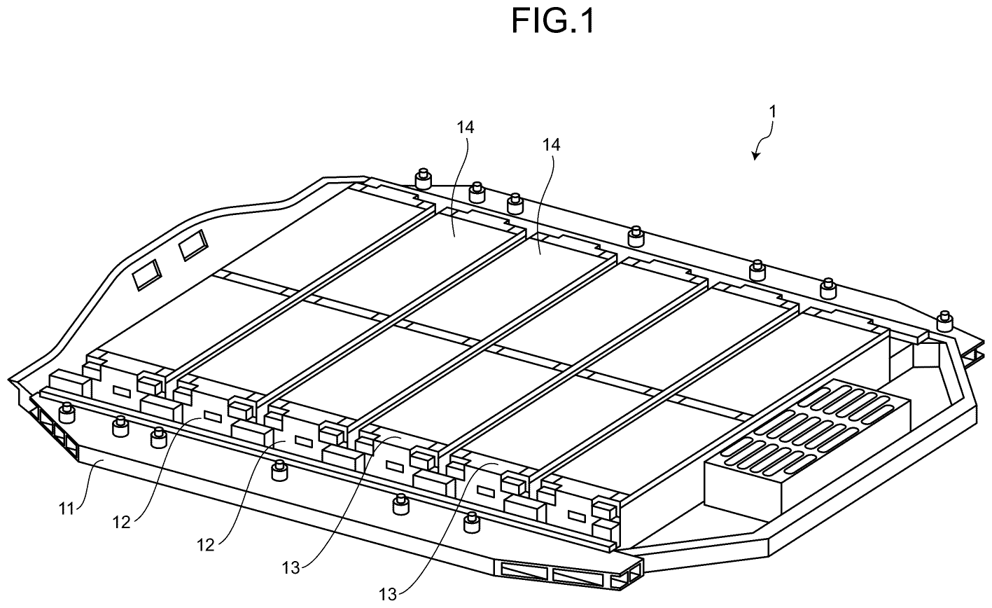

A battery pack 1 according to an embodiment includes, as illustrated in FIG. 1, a case 11, a battery module 12, a skeleton part 13, and an upper surface portion 14. Of the components of the battery pack 1, a combination of the skeleton portion 13 and the upper surface portion 14 functions as a top protective structure for protecting the upper surface of the battery module 12.

The case 11 is provided for accommodating a plurality of battery modules 12.

In the battery module 12, a plurality of battery cells are stacked. The battery module 12 includes, for example, a plurality of battery cells and an elastic member interposed between the battery cells.

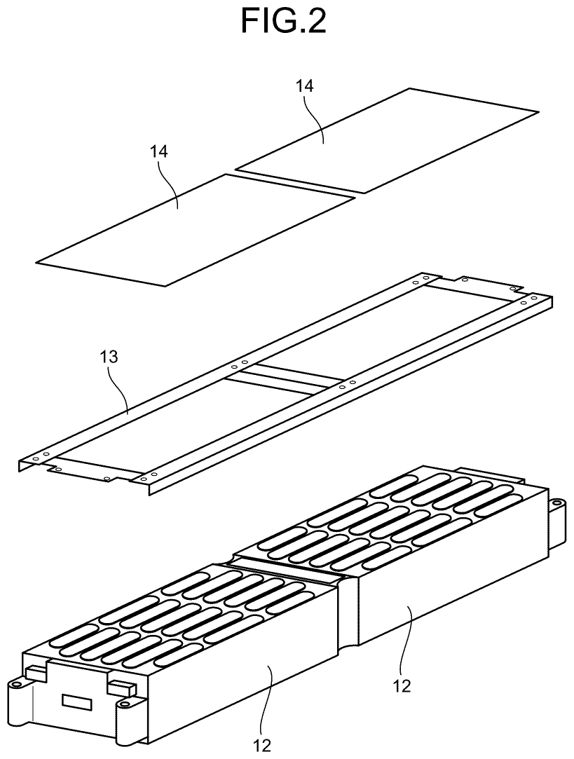

The skeletal portion 13 is provided for improving the strength of the battery pack 1. This skeleton portion 13 is formed into a frame shape. Further, the skeleton portion 13 is disposed over a plurality (here two) of battery modules 12 as illustrated in FIG. 2. The skeleton portion 13 may be constituted by an integral frame by a single member, or may be constituted by a frame in which a plurality of members are combined by rivets or the like.

The upper surface portion 14 is for covering the upper surface of the battery module 12. The upper surface portion 14 is formed in a plate shape, for example, is constituted by mica (mica plate). Further, a plurality of the (in this case, two) upper surface portions 14, as illustrated in FIG. 2, are arranged on the skeleton portion 13.

Here, even in the related-art battery pack, the upper surface portion made of a mica plate is disposed on the battery module. Then, the upper surface portion is provided with a flue gas outlet for flue gas at the time of smoke generation of the battery module. Therefore, in the related-art battery pack, there is a problem of low strength and resistance (against, for example, foot stomp and heat input) of the upper surface portion. Further, when the smoke outlet is provided on the upper surface portion, with respect to the battery module adjacent to a battery module that emits smoke, it takes high-temperature gas and spouting, chain smoke generation may be promoted.

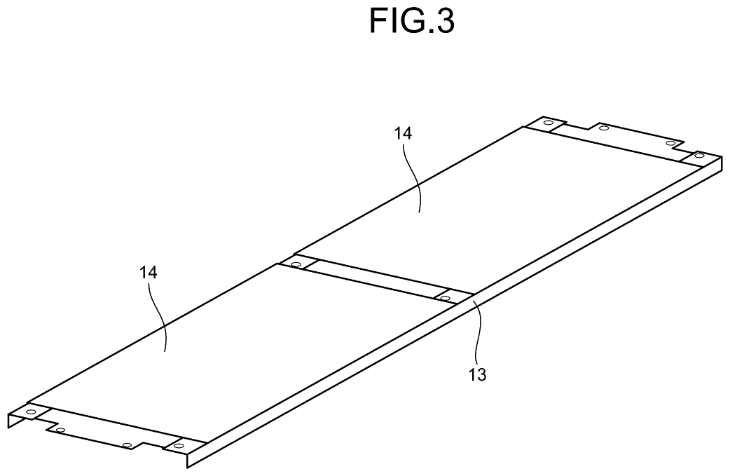

Therefore, in the battery pack according to the embodiment, the upper surface portion 14 is fixed to the skeleton portion 13 with a fixing force in a manner that upper surface portion 14 is released from the skeleton portion 13 with a pressure (stress) or temperature when the battery module 12 emits smoke. That is, as illustrated in FIG. 3, in normal time (when non-smoking battery module 12), the upper surface portion 14 and the skeleton portion 13 are easily fixed to each other with a weak fixing force.

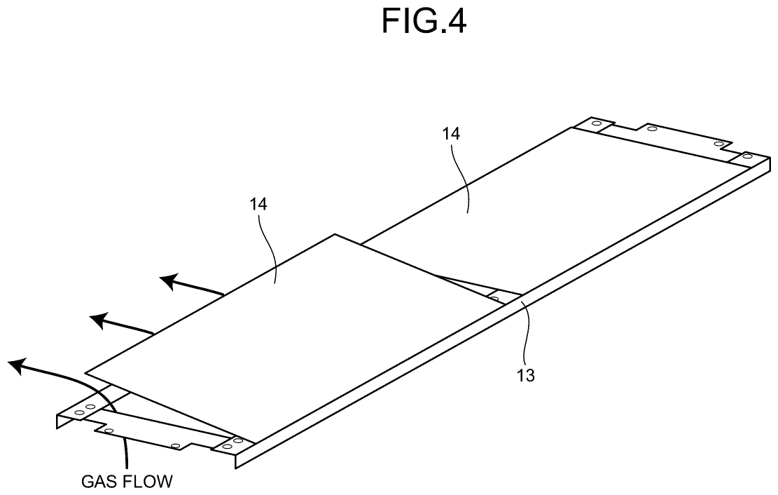

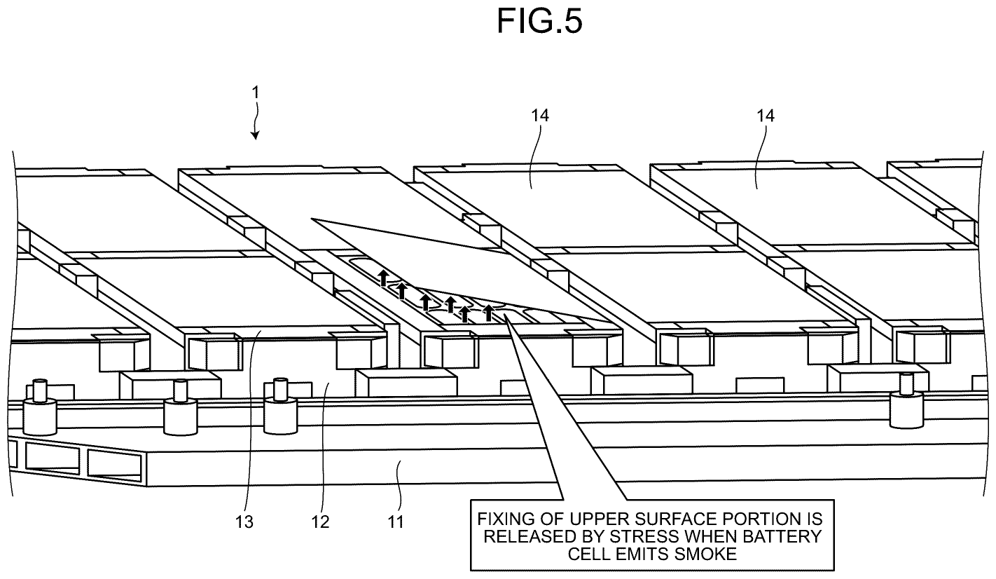

On the other hand, as illustrated in FIGS. 4 and 5, when the battery module 12 emits smoke, by the pressure of the gas when the battery module 12 is smoked, the fixing of the upper surface portion 14 relative to the skeleton portion 13 is released. That is, at the time of the smoke generation of the battery module 12, by positively dropping off the upper surface portion 14 from the skeleton portion 13 to promote discharge gas. In a case where the smoke generation of the battery module 12 occurs, although the upper surface portion 14 is destroyed, it is possible to protect the adjacent battery module 12 from high-temperature gases and ejecta, so that it is possible to suppress chain smoke generation.

As a method of easily fixing the upper surface portion 14 to the skeleton portion 13, there are, for example, a method of cutting into a predetermined portion of the upper surface portion 14 (a portion to be fixed to the skeleton portion 13), a method of fastening both using a member having a weak fixing force, and the like. Further, for example, based on the measurement data of the pressure of the gas at the time of smoke generation of the battery module 12, the weight and the area of the upper surface portion 14, or the like, the required fixing force may be estimated, so that the upper surface portion 14 is fixed to the skeleton portion 13 with the estimated fixing force.

According to the battery pack according to the embodiment described above, by having a skeleton portion 13 for improving the strength, and an upper surface portion 14 which functions as a smoke exhaust outlet in an emergency, it is possible to achieve both external force stress and smoke exhaust countermeasures. That is, in a normal case, by closing the upper surface of the battery module 12 by the upper surface portion 14, it is possible to take measures against external stress. Further, in case of the smoke generation of the battery module 12, by releasing the fixing of the upper surface portion 14 to release the blocking of the upper surface of the battery module 12, it is possible to perform smooth flue gas.

According to the present disclosure, by providing a skeleton portion for improving the strength and an upper surface portion which functions as a smoke exhaust outlet in an emergency, it is possible to achieve both external force stress and smoke exhaust countermeasures.

Further effects and variations can be readily derived by one skilled in the art. Thus, the broader aspects of the present disclosure are not limited to the specific details and representative embodiments represented and described above. Accordingly, various changes may be made without departing from the spirit or scope of the overall present disclosure defined by the appended claims and their equivalents.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a plurality of battery modules;
a frame-shaped skeleton portion disposed on the battery modules; and
an upper surface portion disposed on the skeleton portion, wherein
the upper surface portion is fixed to the skeleton portion with a fixing force in a manner that the fixing with skeleton portion is released with a pressure generated when at least one of the battery modules emits smoke.
